(19) United States
(12) Patent Application Publication
(10) Pub. No.: US 2003/0097263 A1
(43) Pub. Date: May 22, 2003

(54) Decision tree based speech recognition

(76) Inventor: Hang Shun Lee, Sydney (AU)

Correspondence Address: MOTOROLA, INC., 1303 EAST ALGONQUIN ROAD, IL01/3RD, SCHAUMBURG, IL, 60196

(21) Appl. No.: 09/993,275

(22) Filed: Nov. 16, 2001

(51) Int. Cl. G10L 15/12

(52) U.S. Cl. 704/236

(57) ABSTRACT

A method (200) is described for creating decision trees for processing a sampled signal indicative of speech. The method (200) includes providing model sub vectors (220) from partitioned statistical speech models of phones, the models comprising vectors of mean values and associated variance values. The method (200) then provides for statistically analyzing (230) the model sub vectors of mean values to provide projection vectors indicating directions of relative maximum variance between the sub vectors and thereafter the method provides for calculating projection values (240) of the projection vectors. A selecting potential threshold values (260) step is then applied, the potential threshold values being determined from analysis of a range of the projection values. Finally a step of creating the decision trees (270) is effected to provide a decision tree having decisions to divide the model sub vectors into groups, the groups being leaves of the tree. The decisions are based upon selected threshold values selected from the potential threshold values, the selected threshold values being selected by change in variance between said model sub vectors the variance being determined from said mean values and associated variance values. There is also described a method for speech recognition (300) that uses the decisions trees created by the method (200).

### FIELD OF THE INVENTION

This invention relates to speech recognition. The invention is particularly useful for, but not necessarily limited to, large vocabulary speech recognition based upon binary decision trees for reducing speech recognition search space.

### BACKGROUND OF THE INVENTION

A large vocabulary speech recognition system recognises many received uttered words. In contrast, a limited vocabulary speech recognition system is limited to a relatively small number of words that can be uttered and recognized. Applications for limited vocabulary speech recognition systems include recognition of a small number of commands or names.

Large vocabulary speech recognition systems are being deployed in ever increasing numbers and are being used in a variety of applications. Such speech recognition systems need to be able to recognise received uttered words in a responsive manner without a significant delay before providing an appropriate response.

Large vocabulary Speech recognition systems use correlation techniques to determine likelihood scores between uttered words (an input speech signal) and characterizations of words in acoustic space. These characterizations can be created from acoustic models that do not require training data from one or more speakers and are therefore referred to as large vocabulary speaker independent speech recognition systems.

For a speaker independent large vocabulary speech recognition system, a large number of speech models is required in order to sufficiently characterise, in acoustic space, the variations in the acoustic properties found in an uttered input speech signal. For example, the acoustic properties of the phone /a/ will be different in the words “had” and “ban”, even if spoken by the same speaker. Hence, phone units, known as context dependent phones, are needed to model the different sound of the same phone found in different words.

A speaker independent large vocabulary speech recognition system typically spends an undesirable large portion of time finding matching scores, in the art known as the likelihood scores, between an input speech signal and each of the acoustic models used by the system. Each of the acoustic models is typically described by a multiple Gaussian probability density function (pdf), with each Gaussian described by a mean vector and a covariance matrix. In order to find a likelihood score between the input speech signal and a given model, the input has to be matched against each Gaussian. The final likelihood score is then given as the weighed sum of the scores from each Gaussian member of the model. The number of Gaussians in each model is typically of the order of 8 to 64.

It is well known that not all Gaussians within a speech model generate a high score for a given input speech signal. For a Gaussian with mean values considerable different from the input signal values, the score is very close to 0 as the input is at the “tail” of the Gaussian distribution. This implies that the contribution of such a Gaussian to the overall likelihood score will be negligible. Hence, the calculation of the likelihood score for a model using all the Gaussians can be approximated accurately by using only a subset of the Gaussians within the model.

The subset of Gaussians within the model is typically selected using a method known as Gaussian selection in which a subset of the Gaussians in the model set is selected for a particular input speech signal. The subset, also called a Gaussian shortlist, is then used to calculate the likelihood scores for each model. However, the Gaussian shortlist is based upon vector clustering and in order to obtain acceptable real time responses, for large vocabulary speech recognition systems, the number of clusters must be unnecessarily large.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided a method for creating at least one decision tree for processing a sampled signal indicative of speech, the method comprising the steps of:

providing model sub vectors from partitioned statistical speech models of phones, the models comprising vectors of mean values and associated variance values;

statistically analyzing at least some of the model sub vectors of mean values to provide projection vectors indicating directions of relative maximum variance between the sub vectors;

calculating projection values for a plurality of the projection vectors;

selecting potential threshold values from analysis of a range of projection values; and

creating the decision tree having decisions to divide the model sub vectors into groups, the groups being leaves of the tree, wherein the decisions are based upon selected threshold values selected from the potential threshold values, the selected threshold values being selected by change in variance between said model sub vectors the variance being determined from said mean values and associated variance values.

Preferably, the groups have statistical characteristics defining an acoustical subspace.

Suitably, the speech models are based on Gaussian probability distributions.

Preferably, the step of statistically analyzing is further characterized by the projection vectors being calculated by principal component analysis.

Preferably, the potential threshold values are selected from a subset of the projection values.

Suitably, the decisions are based upon an inequality calculation.

Preferably, the inequality calculation relates to inequality between a transpose of a selected model sub vector multiplied by a projection vector and one of said potential threshold values.

The subset is suitably selected from projection vectors having a projection values with greatest variance.

Preferably, the potential threshold values are determined from a range between a minimum and maximum projection values of each of the projection vectors in the subset.

Suitably, the potential threshold values are determined by dividing the range into evenly spaced sub ranges.

Suitably, the decision tree is a binary decision tree.

According to another aspect of this invention there is provided a method for speech recognition comprising the steps of:

providing a sampled speech signal processed into at least one feature vector representing spectral characteristics of a speech signal;

dividing the feature vector into sub feature vectors;

applying each of the sub feature vectors to a corresponding decision tree, to obtain groups of model sub vectors that are likely to indicate at least one phone of the sampled speech signal, the decision tree being created by analysis of the model sub vectors obtained from statistical speech models, wherein the decision tree has decisions based upon selected threshold values selected from potential threshold values, the selected threshold values being selected by change in variance between said model sub vectors the variance being determined from said mean values and variance values associated with said model sub vectors;

selecting a plurality of the model sub vectors from the groups of sub feature vectors to thereby identify a shortlist of model sub vectors; and

processing the shortlist to provide a transcription of the sampled speech signal.

Preferably, the transcription is a text version of the sampled speech signal. The transcription may suitably be a control signal. The control signal may for example activate a function on an electronic device or system.

Preferably, the decision tree may be created by the above method for creating at least one decision tree.

### BRIEF DESCRIPTION OF THE DRAWINGS

In order that the invention may be readily understood and put into practical effect, reference will now be made to a preferred embodiment as illustrated with reference to the accompanying drawings in which:

FIG. 1 is a schematic block diagram of a speech recognition system in accordance with the invention;

FIG. 2 is a flow diagram illustrating a method for creating a decision tree for processing a sampled signal indicative of speech; and

FIG. 3 is a flow diagram illustrating a method for speech recognition that uses the decision tree created by the method of FIG. 2.

### DETAILED DESCRIPTION OF A PREFERRED EMBODIMENT OF THE INVENTION

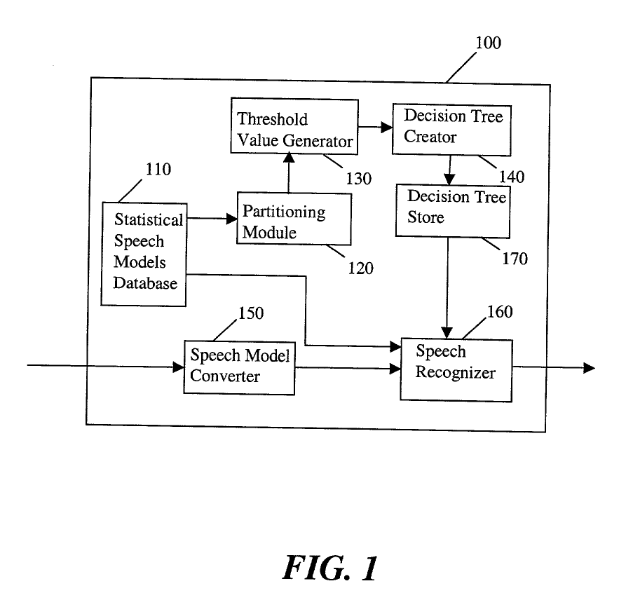

Referring to FIG. 1 there is illustrated a schematic block diagram of a speech recognition system 1 comprising a statistical speech models database 110 with outputs coupled to inputs of a partitioning module 120 and a speech recognizer 160. The partitioning module 120 has an output coupled to an input of a threshold value generator 130 that has an output coupled to an input of a decision tree creator 140. An output of the decision tree creator 140 is coupled to an input of a decision tree store 170. The decision tree store 170 has an output coupled to an input of the speech recognizer 160. There is also a speech model converter 150 having an input for receiving a speech signal. The speech model converter 150 has output coupled to an input of the speech recognizer 160.

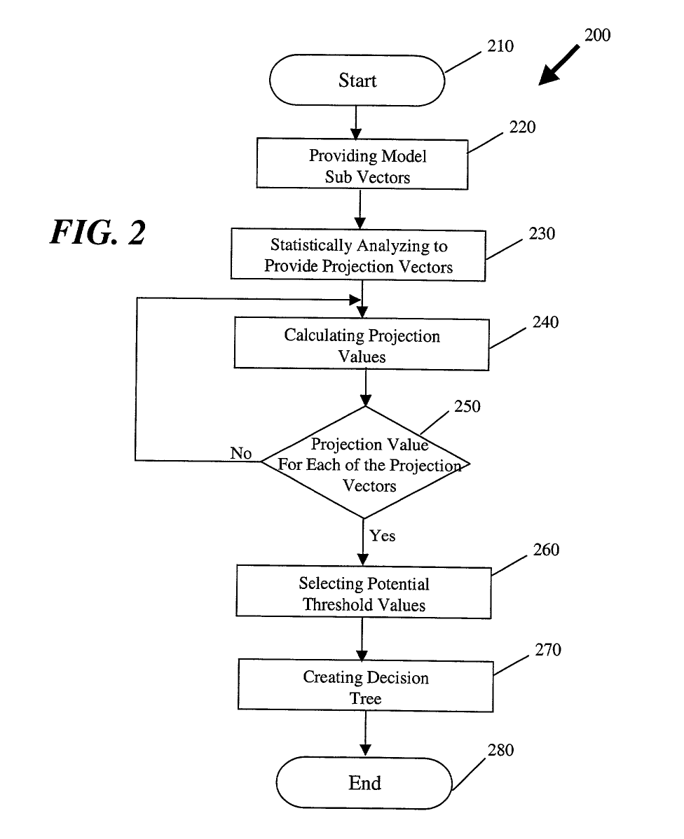

In FIG. 2 there is illustrated a method 200 for creating a decision tree for processing a sampled signal indicative of speech. After a start step 210 the method 200 includes a providing model sub vectors step 220 from partitioned statistical speech models of phones. The statistical speech models comprise vectors of mean values and associated variance values. In this embodiment the statistical speech models are stored in the statistical speech models database 110 and are based on tri-phones modeled by what is known in the art as a Hidden Markov Model (HMM) with multiple states. Each of the states of the HMM is modeled by a multi-mixture Gaussian Probability Density Function. Accordingly the speech models are based on Gaussian probability distributions or Gaussian mixtures where where the Gaussian mixtures {gⱼₘ} are of the form:

{gⱼₘ}={wⱼₘ, μⱼₘ, Σⱼₘ} -(1)

where wⱼₘ is a scalar weight, μⱼₘ is a mean value vector and Σⱼₘ is a covariance matrix each being for an mth gaussian mixture in a jth HMM state. The covariance matrix Σⱼₘ is typically a diagonal matrix with only the leading diagonal having non-zero values and can be simplified into a variance vector σⱼₘ.

If, for instance, the variance vector σⱼₘ and mean value vector μⱼₘ are both a 39 dimension vectors, then the partitioning module 120 at step 220 partitions each of the vectors μⱼₘ and σⱼₘ into three respective model sub vectors μⱼₘ₁, μⱼₘ₂, μⱼₘ₃ and σⱼₘ₁, σⱼₘ₂, σⱼₘ₃. Each of the model sub vectors μⱼₘ₁, μⱼₘ₂, μⱼₘ₃, σⱼₘ₁, σⱼₘ₂ and σⱼₘ₃ is a 13 dimension vector containing elements from the original respective mean value vector μⱼₘ or variance vector σⱼₘ. The sub vector μⱼₘ₁ consists of the first 13 elements from the mean value vector μⱼₘ. The corresponding sub vectors μⱼₘ₂ and μⱼₘ₃ consists respectively of the next 13 elements and the last 13 elements from μⱼₘ. The same partition method used to partition the mean value vector μⱼₘ is applied to the variance vector σⱼₘ. That is, the sub vectors σⱼₘ₁, σⱼₘ₂, σⱼₘ₃ consists respectively of the first 13 elements, the next 13 elements and the last 13 elements of the variance vector σⱼₘ. The providing model sub vectors step 220 is applied to all the statistical speech models of phones presented in the statistical speech models database 110. For example, the speech models database may contain 40,000 Gaussian mixtures, which in turn will generate 40,000×3 partitions of Gaussian mixtures {gⱼₘ}=120,000 model mean value sub vectors from the mean value vectors μⱼₘ and another 120,000 model variance sub vectors from the variance vectors σⱼₘ. It should be noted at this point that each of the three partitions Gaussian mixtures {gⱼₘ} corresponds to a decision tree created as described below.

The model sub vectors generated in step 220 from all the speech models in database 110 are then statistically analyzed in step 230 to provide projection vectors that indicate the directions of relative maximum variance between the model mean value sub vectors. A statistical analysis method known in the art as Principal Component Analysis as described in Chapter 12 (12-1, 12-2) in the S-PLUS Guide to Statistical and Mathematical Analysis published by StatSci, Seattle, Wash., is used to calculate the projection vectors. This reference is included herewith as part of this specification. In particular, Principal Component Analysis is applied for each partition of 40,000 model mean value sub vectors μⱼₘ₁, μⱼₘ₂, μⱼₘ₃ according to the equation:

C=UΛU^{T} -(2)

where C is the covariance matrix of dimension 13×13 computed from the 40,000 mean value sub vectors; U is a matrix of dimension 13×13 with each row of U corresponding to a projection vector; and Λ is a 13×13 diagonal matrix where a value of the i^{th} diagonal element (i=1 to 13) measures the relative variance between the sub vectors in the direction associated with the project vector in the i^{th} row of matrix U. The diagonal values of Λ are known in the art as principal components and are ranked in descending order. Typically, most of the variance between the sub vectors can be accounted for by the first 4 principal components and their corresponding projection vectors. Hence only 4 of the 13 projection vectors are chosen and thereby provided as an output of the partitioning module 120 in step 230. Accordingly, for each of the three mean value sub vector partitions μⱼₘ₁, μⱼₘ₂, μⱼₘ₃ there are a total of 12 projection vectors.

A calculating projection values step 240 is then effected in which projection values are calculated for each of the 12 mean value projection vectors (four per partition) in the threshold value generator 130. A projection vector is selected and a projection value is calculated for each of the corresponding 40,000 mean value sub vectors per partition according to the equation:

μjmK^{T}uᵢ -(3)

Where K=1, 2, 3 is an index indicating each of the 3 partitions and i=1, 2, 3, 4 is an index indicating each of the 4 mean value projection vectors uᵢ.

After the step 240, a test step 250 is effected in which the threshold value generator 130 checks whether or not projection values have been calculated for each of the projection vectors of a partition. If not, an unprocessed projection vector is selected and applied to step 240 for calculating its projection values. Otherwise, the method moves to a selecting potential threshold values step 260, where the projection values are analyzed, by the threshold value generator 130, in order to select potential threshold values from a range of projection sub values.

In the selecting potential threshold values step 260, a potential threshold values are selected for each of the mean value projection vectors from analysis of the 40,000 projection values per partition. For instance, a range of projection sub values between the minimum and maximum projection values can be determined by dividing the range into evenly spaced sub ranges according to the equation:

$${p}_{Ki}^{min} + ( b + 0.5 ) ( \frac{{p}_{Ki}^{min} - {p}_{Ki}^{min} )}{B} ) \qquad ( 4 )$$

where p_{Ki}^{max} and p_{Ki}^{min} are the maximum and minumum projection values respectively; K=1, 2, 3 is an index indicating each of the 3 partitions; i=1, 2, 3, 4 is an index indicating each of the 4 projection vectors uᵢ; b=1, 2, . . . B is an index for a particular sub range; and B, typically chosen to be 10, is the total number of sub ranges between the minimum and maximum projection values. Hence, each of the 12 projection vectors has 10 associated potential threshold values selected from a subset of the projection values with greatest variance.

Next, a creating decision tree step 270, is effected to create binary decision trees having decisions to divide the model sub vectors into groups is created in the decision tree creator 140. These decisions divide the sub vectors into groups, the groups being leaves of the trees and the decisions are based on selected threshold values selected from the potential threshold values in step 260. In particular, decisions are based on the following inequality calculation:

x^{T}uᵢ≧kᵢ(b) -(5)

where x is a selected model sub vector of mean values, uᵢ is a projection vector and kᵢ(b) is a potential threshold value associated with the projection vector computed in step 260 according to equation (4).

A binary decision tree is created for each of the three partitions using the corresponding 40,000 model mean value sub vectors. Each non-leaf node node of the created decision tree has an associated question of the form as in equation (5). For each non-leaf node, a question is selected from the total of 4 projection vectors (four per partition) multiplied by 10 threshold values to create 40 potential questions. One of the questions is then selected to maximise the change in variance between the sub vectors within the parent node and the sub vectors within the left and right child nodes.

The variance vⁿ of the data in the nth tree node is defined as:

$${v}^{n} = {{\sum }^{D}}_{i = 1} log [ {v}^{n} ( i ) ] \qquad ( 6 )$$

where D=13, is the dimension of the sub vectors. vⁿ (i) is the data variance for the i^{th} dimension in the sub-vector and is given by the following equation:

$${v}^{n} ( i ) = {\sum }_{jε 1 … L} ( {σ}_{j}^{2} ( i ) + {μ}_{j}^{2} ( i ) ) / L - {( {\sum }_{j = 1 … L} {μ}_{j} ( i ) / L )}^{2} \qquad ( 7 )$$

where j is the index of sub vectors; L is the number of sub-vectors assigned to the node; σⱼ(i) and μⱼ(i) are the i^{th} dimensional element of the j^{th} sub vector mean and standard deviation for the nth node respectively.

The change in variance d is then determined by:

d=v^{parent}−(v^{left}+v^{right}) -(8)

where v^{parent}, v^{left}, v^{right} represents the variance of the sub vectors in the parent, left child and right child node respectively.

The decision tree has a number of leaf nodes where each leaf corresponds to a group of model sub vectors sharing similar statistical characteristics that together define an acoustical subspace.

The sub vector in a leaf node satisfies the following conditions:

(1) The number of model sub vectors is less than a threshold, chosen to be 10; and

(2) The maximum possible change in variance according to equations (6)-(8) is less than a threshold, chosen to be 0.1.

There are three decision trees created in the decision tree creator 140 at step 270, each corresponding to one of the three partitions. Each of the non-leaf nodes has a decision associated therewith based on the inequality equation -(5), the decision of each non-leaf node is selected to maximise change in variance between sub vectors and is of the form:

x^{T}uᵢ≧kᵢ -(9)

Where x is a feature vector described below, uᵢ is a selected projection vector for the node; and kᵢ is a selected threshold value associated with the projection vector uᵢ.

The decision trees are stored in the decision tree store 170 and the method 200 terminates at an end step 280.

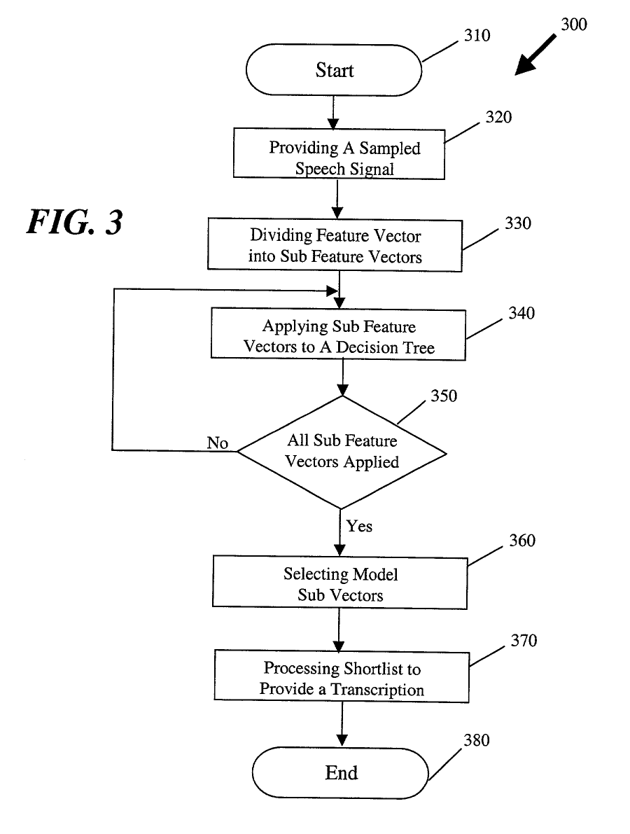

Referring to FIG. 3, there is illustrated a method 300 for speech recognition that uses the decision tree created by the method 200. After a start step 310, speech recognition commences in which the method 300 first provides, at a providing step 320, a sampled speech signal from incoming speech utterance that is received and processed by the speech model converter 150. The sampled speech signal represents spectral characteristics of the speech signal that is processed into one or more feature vectors by the speech model converter 150. Each feature vector is the same dimension (39) as the mean value vector uⱼₘ and variance vector σⱼₘ of the statistical speech models stored in the statistical models database 110. The feature vectors represent the spectral characteristics of the underlying speech signal. For instance, a method known in the art as mel-frequency cepstral coefficients (MFCCs) is used. A typical known method of finding the MFCCs is included herewith by reference to the paper “Comparison of Parametric Representations for Monosyllabic Word Recognition in Continuous Spoken Sentences.” by David and Mermelstein, published in IEEE Transactions on Acoustic Speech and Signal Processing, Vol. 28, pp. 357-366.

Next, a dividing feature vector step 330 is effected in the speech recognizer 160 in which the feature vectors are divided into sub feature vectors. The identical partition method used in step 220 for the statistical speech models is used in step 330. In particular, each 39 dimension feature vector x is divided into three 13-dimension sub feature vectors x₁, x₂, x₃ that consist respectively of the first 13 elements, the next 13 elements and the last 13 elements thereof.

Each of the sub feature vectors is then applied, at an applying step 340, to the corresponding one of three decision trees in the decision tree store 170 which is accessed by the speech recognizer 160. The applying step applies each of the sub feature vectors to a corresponding decision tree, to obtain groups of model sub vectors that are likely to indicate at least one phone of the sampled speech signal. As will be apparent to a person skilled in the art, each of the three decision trees were created by analysis of model sub vectors obtained from statistical speech models database 110.

The sub feature vector is first applied to the root node of the decision tree by evaluating the decision of equation (9) associated with the root node. The sub feature vector is then assigned to either the left or right child node according to the outcome of the evaluation. The decision of equation (9) associated with the child node chosen is then evaluated with the sub feature vector. The process repeats until a leaf node has been reached and a group of model sub vectors for the sub feature vector is obtained. The group defines an acoustical subspace that indicates at least one phone of the sampled speech signal.

A test step 350 is then effected to check whether or not all the sub feature vectors have been applied to the corresponding decision tree. If not, an unprocessed sub feature vector is selected and applied to its decision tree. Otherwise, the method moves to a selecting step 360 in which model sub vectors are selected to identify and create shortlists of sub vectors.

Each of the feature vectors x is now associated with three groups of model sub vectors obtained from each of the three sub feature vectors x₁, x₂, x₃ and their corresponding decision tree. A shortlist of model vectors is then identified in the selecting step 360 from the model sub vectors in the three groups s₁, s₂ and s₃. In particular, a model vector is evaluated as for whether its model sub vector belongs to the group associated with the feature vector x. If so, a score is assigned to the model vector. A model vector is selected into the shortlist for feature vector x if the total score is greater than a threshold according to the empirically determined equation:

s₁+0.5s₂+0.5s₃>0.9 -(10)

Where s₁, s₂ or s₃ are set to 1 if the corresponding model sub vector is present in their group. Otherwise, s₁, s₂ and s₃ are set to zero. Hence, the strategy used to select the shortlist for a feature vector x is to include a model vector if the model sub vector is at least in group s₁ or if the model sub vector is not in group s₁ then it must be present both group s₂ and group s₃ to be selected as a member of the shortlist.

The shortlists identified for the feature vectors are then processed in a processing step 370 to provide a transcription of the sampled speech signal. This is provided by what known in the art as a decoding method. A typical implementation of a decoding method that is included herewith into this specification can be found in the publication “A One Pass Decoder Design for Large Vocabulary Recognition” by J. J. Odell, V. Valtchev, P. C. Woodland and S. J. Young in Proceedings ARPA Workshop on Human Language Technology, pp. 405-410, 1994.

The transcription is provided at an output of the speech recognizer 160. The transcription in one form is a text version of the sampled speech signal. Alternatively, the transcription may be a control signal to activate a function on an electronic device or system. The method terminates at an end step 380.

Advantageously, the present invention can alleviate the problems with unnecessary processing of distribution “tails” of statistical speech models during speech recognition. The invention also alleviates the overheads associated with unnecessary large clusters affecting speech recognition response times.

The detailed description provides a preferred exemplary embodiment only, and is not intended to limit the scope, applicability, or configuration of the invention. Rather, the detailed description of the preferred exemplary embodiment provides those skilled in the art with an enabling description for implementing preferred exemplary embodiment of the invention. It should be understood that various changes may be made in the function and arrangement of elements without departing from the spirit and scope of the invention as set forth in the appended claims.

We claim:

1. A method for creating at least one decision tree for processing a sampled signal indicative of speech, the method comprising the steps of:
providing model sub vectors from partitioned statistical speech models of phones, the models comprising vectors of mean values and associated variance values;
statistically analyzing at least some of the model sub vectors of mean values to provide projection vectors indicating directions of relative maximum variance between the sub vectors;
calculating projection values for a plurality of the projection vectors;
selecting potential threshold values from analysis of a range of the projection values; and
creating the decision tree having decisions to divide the model sub vectors into groups, the groups being leaves of the tree, wherein the decisions are based upon selected threshold values selected from the potential threshold values, the selected threshold values being selected by change in variance between said model sub vectors the variance being determined from said mean values and associated variance values.

2. A method for creating at least one decision tree as claimed in claim 1, wherein the groups have statistical characteristics defining an acoustical subspace.

3. A method for creating at least one decision tree as claimed in claim 1, wherein the speech models are based on Gaussian probability distributions.

4. A method for creating at least one decision tree as claimed in claim 1, wherein the step of statistically analyzing is further characterized by the projection vectors being calculated by principal component analysis.

5. A method for creating at least one decision tree as claimed in claim 1, wherein the potential threshold values are selected from a subset of the projection values.

6. A method for creating at least one decision tree as claimed in claim 5, wherein the decisions are based upon an inequality calculation.

7. A method for creating at least one decision tree as claimed in claim 6, wherein the inequality calculation relates to inequality between a transpose of a selected model sub vector multiplied by a projection vector and one of said potential threshold values.

8. A method for creating at least one decision tree as claimed in claim 5, wherein the subset is suitably selected from projection vectors having a projection values with greatest variance.

9. A method for creating at least one decision tree as claimed in claim 8, wherein the potential threshold values are determined from a range between a minimum and maximum projection values of each of the projection vectors in the subset.

10. A method for creating at least one decision tree as claimed in claim 9, wherein the potential threshold values are determined by dividing the range into evenly spaced sub ranges.

11. A method for creating at least one decision tree as claimed in claim 1, wherein, the decision tree is a binary decision tree.

12. A method for speech recognition comprising the steps of:
providing a sampled speech signal processed into at least one feature vector representing spectral characteristics of a speech signal;
dividing the feature vector into sub feature vectors;
applying each of the sub feature vectors to a corresponding decision tree, to obtain groups of model sub vectors that are likely to indicate at least one phone of the sampled speech signal, the decision tree being created by analysis of the model sub vectors obtained from statistical speech models, wherein the decision tree has decisions based upon selected threshold values selected from potential threshold values, the selected threshold values being selected by change in variance between said model sub vectors the variance being determined from said mean values and variance values associated with said model sub vectors;
selecting a plurality of the model sub vectors from the groups of sub feature vectors to thereby identify a shortlist of model sub vectors; and
processing the shortlist to provide a transcription of the sampled speech signal.

13. A method for speech recognition as claimed in claim 12, wherein the transcription is a text version of the sampled speech signal.

14. A method for speech recognition as claimed in claim 12, wherein the transcription is a control signal.

15. A method for speech recognition as claimed in claim 14, wherein the control signal activates a function on an electronic device.

16. A method for speech recognition as claimed in claim 12, wherein the potential threshold values are selected from a subset of projection values obtained from the model sub vectors.

17. A method for speech recognition as claimed in claim 16, wherein the decisions are based upon an inequality calculation.

18. A method for speech recognition as claimed in claim 17, wherein the inequality calculation relates to inequality between a transpose of a selected model sub vector multiplied by an associated projection vector and one of said potential threshold values.

19. A method for speech recognition as claimed in claim 16, wherein the subset is suitably selected from projection vectors having projection values with greatest variance.

20. A method for speech recognition as claimed in claim 19, wherein the potential threshold values are determined from a range between a minimum and maximum projection values of each of the projection vectors in the subset.

21. A method for speech recognition as claimed in claim 12, wherein the potential threshold values are determined by dividing the range into evenly spaced sub ranges.
